(19) United States
(12) Patent Application Publication
(10) Pub. No.: US 2011/0066965 A1
(43) Pub. Date: Mar. 17, 2011

(54) ELECTRONIC BOOK WITH ENHANCED FEATURES

(75) Inventor: Ada Saulai Choi, San Diego, CA (US)

(73) Assignees: SONY CORPORATION; SONY ELECTRONICS INC.

(21) Appl. No.: 12/559,914

(22) Filed: Sep. 15, 2009

(51) Int. Cl. G06F 3/048; G06F 17/30

(52) U.S. Cl. 715/776; 345/107; 707/E17.108

(57) ABSTRACT

An electronic book allows a user to select portions of text from an electronic book file and copies the portions into a summary document, ordering the portions in the summary document in the same order the portions appeared in the book. The portions can be accompanied by page numbers or links to the book from which they came so that a user can easily refer back to the book at a location corresponding to an interesting entry in the summary document.

### FIELD OF THE INVENTION

The present invention relates generally to electronic books.

### BACKGROUND OF THE INVENTION

Electronic books have been provided in which a person can read electronic book files stored on a storage medium in a compact, hand-held housing. Text is presented on a display of the housing, and more than a single electronic book can be stored on the storage medium. In this way, a person can in effect transport a large number of books for reading at the person's leisure in a single lightweight electronic book form factor. As recognized herein, such electronic books can be made even more convenient and user-friendly particularly to aid student study of e-book material.

### SUMMARY OF THE INVENTION

An electronic book includes a housing, a display supported on the housing, and a digital processor in the housing. A tangible computer-reader storage medium is in the housing and is accessible to the processor, and electronic book files are stored on the medium for presentation of text represented by the files on the display. The processor receives user inputs selecting respective portions of an electronic book and copies the portions into an electronic summary document in a sequence in which the portions are arranged in the electronic book. Each portion in the summary document includes location information useful for identifying respective locations in the electronic book in which the portions appear.

The location information may include a page number and/or a link to the electronic book. In some embodiments the processor automatically initiates an Internet search request using at least one term in a portion in response to entry of the portion into the summary document. The processor can display “N” search results received in response to the search request, and “N” can be defined by a user of the electronic book.

If desired, the portions entered into the summary document can be associated with respective electronic flash cards responsive to user input.

In another aspect, an electronic book includes a housing, a display supported on the housing, and a digital processor in the housing. A tangible computer-reader storage medium is in the housing and is accessible to the processor, and electronic book files are stored on the medium for presentation of text represented by the files on the display. The processor receives user inputs selecting respective portions of an electronic book and establishes respective electronic flash cards responsive to user input.

In another aspect, an electronic book apparatus has an electronically stored electronic book and a processor accessing the electronic book. The processor receives user selections of portions of text from the electronic book. The portions are copied into a summary document by the processor. The processor orders the portions in the summary document in the same order the portions appeared in the book, and the portions in the summary document are accompanied by page numbers or links to the book from which they came so a user can easily refer back to the book at a location corresponding to an interesting entry in the summary document.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a perspective view of an example electronic book in the closed configuration;

FIG. 2 is a perspective view showing the electronic book of FIG. 1 in the open configuration;

FIG. 3 is a perspective view of an example electronic book with the processor, storage medium, and transceivers shown schematically;

FIG. 4 is a screen shot showing a user interface (UI) for selecting the summary function;

FIG. 5 is a flow chart of example summary function logic;

FIG. 6 is a screen shot showing a user interface (UI) for selecting the flash card function; and

FIG. 7 is a flow chart of example flash card function logic.

### DETAILED DESCRIPTION OF THE PREFERRED EMBODIMENT

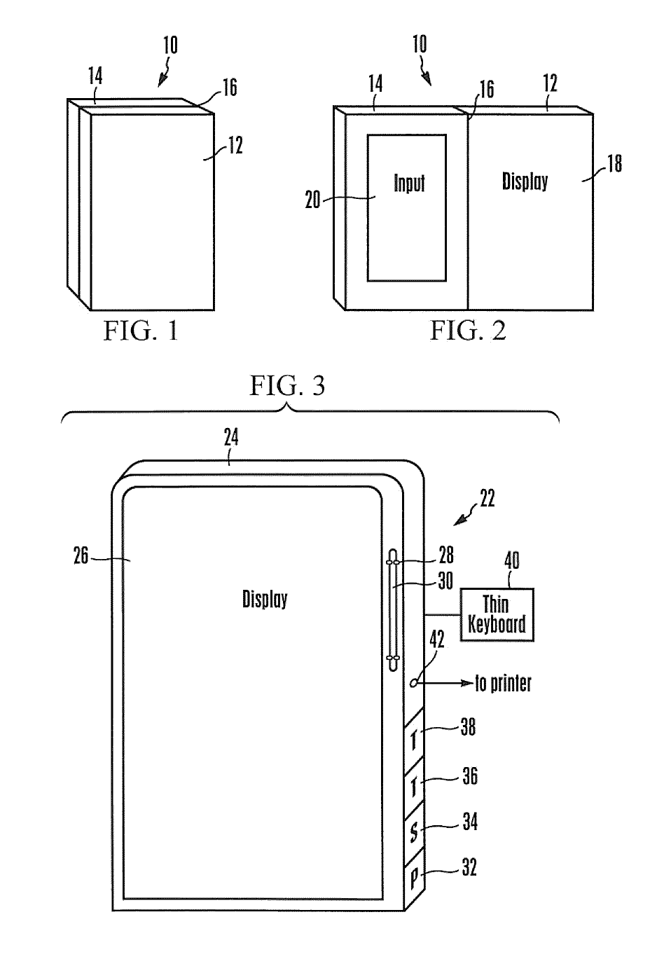

Referring initially to FIGS. 1 and 2, an example electronic book 10 is shown that can have, in one embodiment, a foldable configuration to mimic opening and closing a paper book. Specifically, the electronic book 10 may have a rigid lightweight plastic “cover” member 12 joined to a rigid lightweight plastic “back” member 14 along a hinge 16 for movement between an open configuration (FIG. 2), wherein an electronic display 18 of the “cover” member 12 is exposed for viewing, and a closed configuration (FIG. 1), wherein the display 18 is not exposed because it lies flush against the inside surface of the “back” member 14. If desired, an input device 20 such as a keyboard and/or mouse or other cursor control/point and click device may be provided on, e.g., the “back” member 14.

FIG. 3 shows an example electronic book 22 that may not be foldable in contrast to the book 10 in FIGS. 1 and 2, it being understood that the book 10 shown in FIGS. 1 and 2 may incorporate the features of the electronic book 22 shown in FIG. 3 in, e.g., the “cover” member 12 of the book 10. The electronic book 22 includes a lightweight portable plastic housing 24 bearing an electronic display 26 that may be a touch screen display. Accordingly, if desired the housing 24 may include one or more stylus holders 28 such as plastic clips for holding an elongated rigid typically plastic stylus 30, e.g., vertically on the housing with respect to the “top” and “bottom” of the housing, for use in inputting signals on the display 26 when it is a touch screen display. Without limitation the display 26 may be a liquid crystal display (LCD), light emitting diode display (LED), or other appropriate electronic display technology, and may further include audio display capability, e.g., a speaker.

Using the input device(s) above a person can enter signals to a digital processor 32 within the housing 24. In turn, the processor 32 can access a tangible computer-reader storage medium 34 such as but not limited to disk-based storage and/or solid state storage to execute logic herein. Electronic book files can also be stored on the medium 34. It is to be understood that the processor 32 controls the display 26 to present user interfaces including a list of titles stored on the medium 34, command input elements to support the book-to-book communication set forth below, book text from files on the medium 34, and when the display 26 is a touch screen display, an image of an input device such as a keyboard with which the user can input alpha-numeric signals using, e.g., the stylus 30.

In some embodiments the processor 32 may communicate with one or more wireless transceivers for purposes to be shortly divulged. In the embodiment shown in FIG. 3, the processor 32 communicates with a long-range wireless transceiver 36 and a short-range wireless transceiver 38. Without limitation the short-range transceiver 38 may be a Bluetooth transceiver or other short-range high bandwidth transceiver technology and the long-range transceiver 36 may be a Wi-Fi transceiver or ultra wideband (UWB) transceiver or wireless telephony transceiver or other appropriate transceiver.

Using, e.g., the stylus 30 or other object a person may select a “highlight” selector presented on the display 26 to highlight text that is present on the display to indicate its selection. Also, the person may enter handwritten notes in the “margins” of text presented on the display, with the processor 32 executing a handwriting recognition module stored on the medium 34 to generate and store electronic alpha-numeric characters representative of the handwriting in the relevant portion of the electronic book file. In this way, a person can annotate an electronic book or the below-described summary document with comments at the location in the book file to which the comments pertain.

If desired, a thin keyboard 40 or other key entry device may be plugged into the e-book to communicate user input signals to the processor 32. Also, an output port 42 such as but not limited to a universal serial bus (USB) port may be provided that can be connected to a printer to allow a user to print selected text under control of the processor 32. Yet again, the processor 32 can wirelessly send data to a printer through, e.g., the short-range transceiver 38.

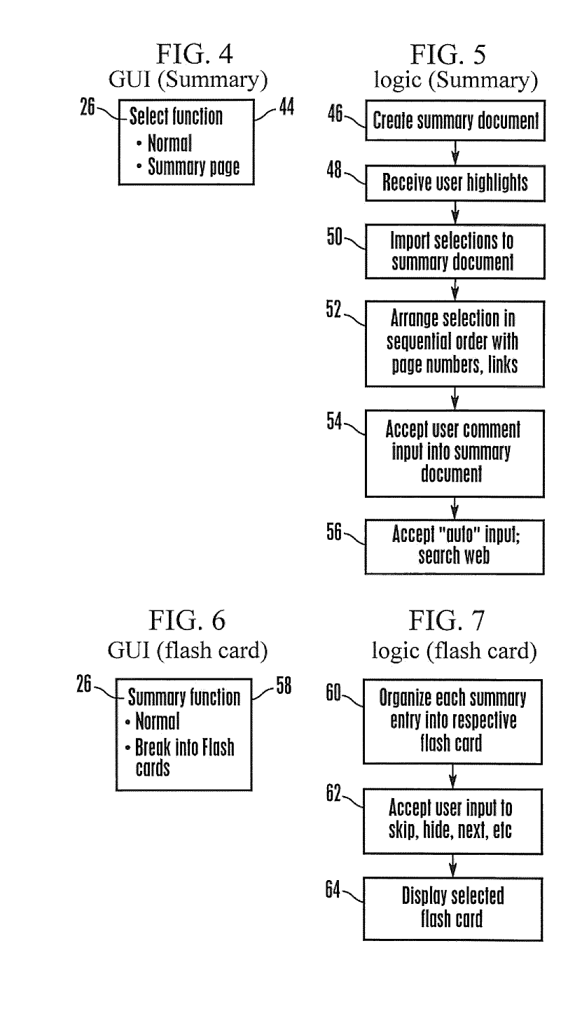

FIG. 4 shows that the processor 32 may present on the display 26 a user interface 44, permitting the user to select, via, e.g., touch screen input with finer or stylus or keyboard input, a “summary page” function. This invokes summary document logic, an example of which is shown in FIG. 5.

Commencing at block 46, the processor 32 in response to a selection of the summary function creates a summary document, which may be a word processing document. Proceeding to block 48, user selections of material including text and graphics in an electronic book are received as, e.g., the above-mentioned user highlights. When highlighted, the selected material may be made to appear in a different format or color code than the remainder of the material in the book. Or, a selection in an electronic book may be made by making “parenthesis marks” on the touch screen at the beginning and end of the selection.

At block 50, the processor in undertaking the summary function automatically transfers the selected information to the summary document. Block 52 indicates that the individual selected portions from the electronic book can be arranged or laid out in the summary document in sequential order, i.e., in the same order in which they appear in the electronic book from whence they came. Block 52 also indicates that each portion in the summary document can include location information useful for identifying respective locations in the electronic book in which the portions appear. The location information may include, for example, a page number from the electronic book on which the portion appears, a link to the part of the electronic book at which the portion appears, etc. If the link or page number in the summary document is clicked the processor 32 may automatically present on the display 26 the corresponding page from the electronic book.

Proceeding to block 54, the user may insert, by means of, e.g., a stylus or finger against the display 26, additional personal study notes to the summary document. The user can export the summary document to a printer to print, as a summary page for their study to help them memorize and understand content. As mentioned above the port 42 shown in FIG. 1, which may be a USB port which accepts jump drive, can be connected to a printer, or the summary document can wirelessly print directly to the printer using, e.g., the short range transceiver 38.

If desired, a suitable user interface may be presented on the display 26 to enable the user to select whether additional material related to informational portions added to the summary document are to be searched and if so, how many results should be returned. Accordingly, if the user selects further search at block 56, the processor 32 automatically initiates an Internet search request using at least one term or keyword in the portion in response to entry of the portion into the summary document. The keyword may be the first several words of text of the portion, for example. The processor displays “N” search results (by, e.g., listing hyperlinks with short titles of the top “N” results returned) to received in response to the search request. Internet communication may be established using the long-range transceiver 36, and to execute the search the processor 32 may invoke a web browser to go to an Internet search engine, automatically entering the keywords into the search engine.

FIGS. 6 and 7 illustrate that a user may be given the option to break this information/reading summary page into flash card style. As shown by the user interface 58 in FIG. 6, while in the summary mode function the processor 32 may present a list of sub-functions including “normal” summary mode (discussed above), or “break into flash cards” sub-function. When the user selects “flash cards” the processor may execute logic an example of which is shown in FIG. 7.

Commencing at block 60, each summary entry is organized into a respective flash card file. At block 62 user input is received skip the next flash card, hide a flash card, scroll to the next flash card, etc. Selected flash card(s) are displayed at block 64.

Accordingly, an example implementation may have scroll, next page/card button, etc. The user, when the user has memorized a particular “e Flash card”, he can “skip” or “temporary hide” that particular “e-Flash Card” and go to the next one. For difficult flash cards the user can set a “repeat mode” which causes a particular “e-Flash Card” to shuffle, automatically and randomly appearing on the display 26 at a later time.

Additionally, a super list function may be provided for each book the reader reads. This “SUPER LIST” can include multiple bookmarks that the user inserts at desired parts of book or summary document files to help track key concept pages. Under each “item” it can show the key phrases/short summary phrase that the user can input himself, or show key phrases that the user has highlighted. For example, if a user read a technical electronic book months ago, and he starts to forget some details of a key concept, he can go to the “SUPER LIST” function to find that key concept he wants to review, and select the corresponding “bookmark”. The processor 32 in response immediately displays the bookmarked pages, and the user can read that key concept in context again. This will be extremely helpful, for example, during the few days before final exams, to review key concepts.

Additional functionality may be provided. For example, the processor 32 may access a clock or timer to record how long a reader displays a page of an electronic book and to calculate an average display time. The user/reader can see if their reading speed improves over time. Every time the reader reads and article, he can set a hidden timer, which will calculate his reading speed. As result, this statistical information can be stored in the book 10/22. The user can check over the course of the year, if his reading speed has improved or not. The book 10/22 may also come with useful free articles regarding reading/study methods, so that users can also learn how to read and study better.

While the particular ELECTRONIC BOOK WITH ENHANCED FEATURES is herein shown and described in detail, it is to be understood that the subject matter which is encompassed by the present invention is limited only by the claims.

What is claimed is:

1. Electronic book comprising:
a housing;
a display supported on the housing;
a digital processor in the housing;
a tangible computer-reader storage medium in the housing and accessible to the processor, electronic book files being stored on the medium for presentation of text represented by the files on the display;
wherein the processor receives user inputs selecting respective portions of an electronic book and copies the portions into an electronic summary document in a sequence in which the portions are arranged in the electronic book, each portion in the summary document including location information useful for identifying respective locations in the electronic book in which the portions appear.

2. The electronic book of claim 1, wherein the housing is foldable to mimic opening and closing a paper book.

3. The electronic book of claim 1, wherein the location information includes a page number.

4. The electronic book of claim 1, wherein the location information includes a link to the electronic book.

5. The electronic book of claim 1, wherein the processor automatically initiates an Internet search request using at least one term in a portion in response to entry of the portion into the summary document.

6. The electronic book of claim 5, wherein the processor displays “N” search results received in response to the search request, wherein “N” is defined by a user of the electronic book.

7. The electronic book of claim 1, wherein the portions entered into the summary document are associated with respective electronic flash cards responsive to user input.

8. Electronic book comprising:
a housing;
a display supported on the housing;
a digital processor in the housing;
a tangible computer-reader storage medium in the housing and accessible to the processor, electronic book files being stored on the medium for presentation of text represented by the files on the display;
wherein the processor receives user inputs selecting respective portions of an electronic book and establishes respective electronic flash cards responsive to user input.

9. The electronic book of claim 8, wherein the processor, responsive to user input, copies the portions into an electronic summary document in a sequence in which the portions are arranged in the electronic book, each portion in the summary document including location information useful for identifying respective locations in the electronic book in which the portions appear.

10. The electronic book of claim 8, wherein the housing is foldable to mimic opening and closing a paper book.

11. The electronic book of claim 9, wherein the location information includes a page number.

12. The electronic book of claim 9, wherein the location information includes a link to the electronic book.

13. The electronic book of claim 9, wherein the processor automatically initiates an Internet search request using at least one term in a portion in response to entry of the portion into the summary document.

14. The electronic book of claim 13, wherein the processor displays “N” search results received in response to the search request, wherein “N” is defined by a user of the electronic book.

15. An electronic book apparatus comprising:
at least one electronically stored electronic book; and
at least one processor accessing the electronic book; wherein
the processor receives user selections of portions of text from the electronic book, the portions being copied into a summary document by the processor, the processor ordering the portions in the summary document in the same order the portions appeared in the book, the portions in the summary document being accompanied by page numbers or links to the book from which they came so a user can easily refer back to the book at a location corresponding to an interesting entry in the summary document.

16. The apparatus of claim 15, wherein the apparatus is foldable to mimic opening and closing a paper book.

17. The apparatus of claim 15, wherein the processor automatically initiates an Internet search request using at least one term in a portion in response to entry of the portion into the summary document.

18. The apparatus of claim 17, wherein the processor displays “N” search results received in response to the search request, wherein “N” is defined by a user of the electronic book.
